(19) United States
(12) Patent Application Publication
(10) Pub. No.: US 2025/0335325 A1
(43) Pub. Date: Oct. 30, 2025

(54) SELECTION AND CONFIGURATION OF INPUT-OUTPUT SOFTWARE TOOLS FOR EXECUTION OF INPUT-OUTPUT WORKLOADS

(71) Applicant: Dell Products L.P., Round Rock, TX (US)

(72) Inventors: Sameer P. Mohod, Pune (IN); Gaurav Gandhi, Pune (IN); Narayan Behera, Pune (IN); Nandeesh Maheshwarappa, Bengaluru (IN)

(21) Appl. No.: 18/644,701

(22) Filed: Apr. 24, 2024

(51) Int. Cl. G06F 11/34

(52) U.S. Cl. CPC G06F 11/3428

(57) ABSTRACT

An apparatus comprises a processing device configured to obtain a specification of one or more requirements for an input-output workload to be performed by one or more host devices utilizing one or more storage systems. The at least one processing device is also configured to select, based at least in part on the specified requirements for the input-output workload, at least one of a plurality of input-output software tools to utilize for performing at least a portion of the input-output workload, and to configure, based at least in part on the specified requirements for the input-output workload, at least one of the host devices and the storage systems to utilize the selected input-output software tool, to dynamically instantiate the selected input-output software tool on the at least one of the host devices and the storage systems, and to execute the input-output workload utilizing the selected input-output software tool.

### BACKGROUND

Storage arrays and other types of storage systems are often shared by multiple host devices over a network. Applications running on the host devices each include one or more processes that perform the application functionality. Such processes issue input-output (IO) operation requests for delivery to the storage systems. Storage controllers of the storage systems service such requests for IO operations. In some information processing systems, multiple storage systems may be used to form a storage cluster.

### SUMMARY

Illustrative embodiments of the present disclosure provide techniques for selection and configuration of input-output software tools for execution of input-output workloads.

In one embodiment, an apparatus comprises at least one processing device comprising a processor coupled to a memory. The at least one processing device is configured to obtain a specification of one or more requirements for an input-output workload to be performed by one or more host devices utilizing one or more storage systems. The at least one processing device is also configured to select, based at least in part on the specified one or more requirements for the input-output workload, at least one of a plurality of input-output software tools to be utilized for performing at least a portion of the input-output workload, and to configure, based at least in part on the specified one or more requirements for the input-output workload, at least one of the one or more host devices and the one or more storage systems to utilize the selected at least one input-output software tool. The at least one processing device is further configured to dynamically instantiate the selected at least one input-output software tool on the at least one of the one or more host devices and the one or more storage systems, and to execute the input-output workload utilizing the selected at least one input-output software tool.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for selection and configuration of input-output software tools for execution of input-output workloads in an illustrative embodiment.

FIG. 2 is a flow diagram of an exemplary process for selection and configuration of input-output software tools for execution of input-output workloads in an illustrative embodiment.

FIG. 3 shows a process flow for utilizing an input-output tool coordination system in an illustrative embodiment.

FIG. 4 shows a process flow for selecting an input-output tool for running an input-output workload based on specified user requirements in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

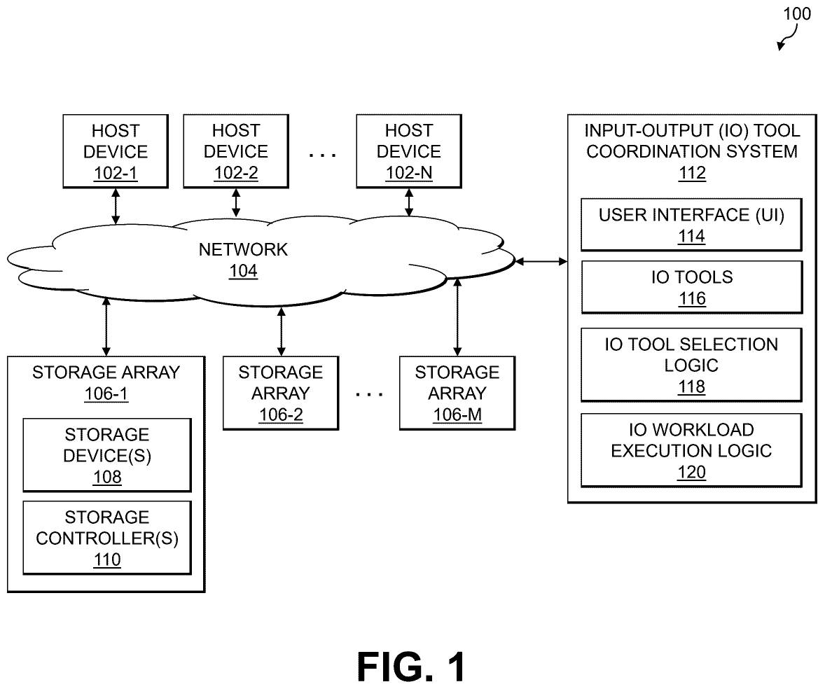

FIG. 1 shows an information processing system 100 configured in accordance with an illustrative embodiment to provide functionality for selection and configuration of input-output (IO) software tools for execution of IO workloads. The information processing system 100 comprises one or more host devices 102-1, 102-2, . . . 102-N (collectively, host devices 102) that communicate over a network 104 with one or more storage arrays 106-1, 106-2, . . . 106-M (collectively, storage arrays 106). Also coupled to the network 104 is an IO tool coordination system 112. The network 104 may comprise a storage area network (SAN).

The storage array 106-1, as shown in FIG. 1, comprises a plurality of storage devices 108 each storing data utilized by one or more applications running on the host devices 102. The storage devices 108 are illustratively arranged in one or more storage pools. The storage array 106-1 also comprises one or more storage controllers 110 that facilitate IO processing for the storage devices 108. The storage array 106-1 and its associated storage devices 108 are an example of what is more generally referred to herein as a “storage system.” This storage system in the present embodiment is shared by the host devices 102, and is therefore also referred to herein as a “shared storage system.” In embodiments where there is only a single host device 102, the host device 102 may be configured to have exclusive use of the storage system. In some embodiments, the storage arrays 106 may be part of a storage cluster (e.g., where the storage arrays 106 may be used to implement one or more storage nodes in a cluster storage system comprising a plurality of storage nodes interconnected by one or more networks), and the host devices 102 are assumed to submit IO operations to be processed by the storage cluster.

The host devices 102 illustratively comprise respective computers, servers or other types of processing devices capable of communicating with the storage arrays 106 via the network 104. For example, at least a subset of the host devices 102 may be implemented as respective virtual machines of a compute services platform or other type of processing platform. The host devices 102 in such an arrangement illustratively provide compute services such as execution of one or more applications on behalf of each of one or more users associated with respective ones of the host devices 102.

The term “user” herein is intended to be broadly construed so as to encompass numerous arrangements of human, hardware, software or firmware entities, as well as combinations of such entities.

Compute and/or storage services may be provided for users under a Platform-as-a-Service (PaaS) model, an Infrastructure-as-a-Service (IaaS) model, Function-as-a-Service (FaaS) and/or a Storage-as-a-Service (STaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

The storage devices 108 of the storage array 106-1 may implement logical units (LUNs) configured to store objects for users associated with the host devices 102. These objects can comprise files, blocks or other types of objects. The host devices 102 interact with the storage array 106-1 utilizing read and write commands as well as other types of commands that are transmitted over the network 104. Such commands in some embodiments more particularly comprise Small Computer System Interface (SCSI) commands, although other types of commands can be used in other embodiments. A given IO operation as that term is broadly used herein illustratively comprises one or more such commands. References herein to terms such as “input-output” and “IO” should be understood to refer to input and/or output. Thus, an IO operation relates to at least one of input and output.

Also, the term “storage device” as used herein is intended to be broadly construed, so as to encompass, for example, a logical storage device such as a LUN or other logical storage volume. A logical storage device can be defined in the storage array 106-1 to include different portions of one or more physical storage devices. Storage devices 108 may therefore be viewed as comprising respective LUNs or other logical storage volumes.

The storage devices 108 of the storage array 106-1 can be implemented using solid state drives (SSDs). Such SSDs are implemented using non-volatile memory (NVM) devices such as flash memory. Other types of NVM devices that can be used to implement at least a portion of the storage devices 108 include non-volatile random access memory (NVRAM), phase-change RAM (PC-RAM) and magnetic RAM (MRAM). These and various combinations of multiple different types of NVM devices or other storage devices may also be used. For example, hard disk drives (HDDs) can be used in combination with or in place of SSDs or other types of NVM devices. Accordingly, numerous other types of electronic or magnetic media can be used in implementing at least a subset of the storage devices 108.

The IO tool coordination system 112 is configured to provide a user interface (UI) 114 which allows users (e.g., of the host devices 102) to submit requests for IO workloads that are to be performed (e.g., on or utilizing one or more of the storage arrays 106). The IO tool coordination system 112 is configured to select IO tools 116 for use in executing the IO workloads (e.g., based on user requirements for the IO workloads). In some embodiments, the IO tool coordination system 112 is used for an enterprise system. For example, an enterprise may subscribe to or otherwise utilize the IO tool coordination system 112 for facilitating execution of IO workloads by users of the enterprise (e.g., where users of the host devices 102 submit requests to perform IO workloads to the IO tool coordination system 112). As used herein, the term “enterprise system” is intended to be construed broadly to include any group of systems or other computing devices. For example, the storage arrays 106 may provide a portion of one or more enterprise systems. A given enterprise system may also or alternatively include one or more of the host devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The IO tool coordination system 112 implements IO tool selection logic 118 and IO workload execution logic 120. The IO tool selection logic 118 is configured to select, for a given IO workload submitted via the UI 114, one or more of the IO tools 116 for use in executing the given IO workload. This selection may be based on explicit user input, based on mapping of user requirements input via the UI 114 to corresponding details regarding the IO tools 116 which are registered, onboarded or otherwise integrated with the IO tool coordination system 112, combinations thereof, etc. In some embodiments, the IO tool selection logic 118 utilizes one or more machine learning models, trained based on historical IO workloads which are executed using different ones of the IO tools 116, to effectively map user requirements for an IO workload to particular ones of the IO tools 116. The IO workload execution logic 120 is configured to execute the given IO workload utilizing the selected ones of the IO tools 116. This may include, for example, deploying the selected ones of the IO tools 116 on one or more of the host devices 102 (e.g., associated with a user submitting the request to perform the given IO workload) and/or on one or more of the storage arrays 106 (e.g., which are associated with the given IO workload). In some embodiments, such deployment includes downloading and configuring any required dependent software packages for the selected ones of the IO tools 116. The IO workload execution logic 120 is also configured to set up one or more of the host devices 102 and/or one or more of the storage arrays 106 for performing the IO workload (e.g., by provisioning suitable storage clients or other entities thereon).

At least portions of the functionality of the IO tool coordination system 112 (e.g., the UI 114, the IO tool selection logic 118 and the IO workload execution logic 120) may be implemented at least in part in the form of software that is stored in memory and executed by a processor.

Although in the FIG. 1 embodiment the IO tool coordination system 112 is shown as being implemented external to the host devices 102 and the storage arrays 106, this is not a requirement. In some embodiments, the IO tool coordination system 112 may be implemented internal to one or more of the host devices 102 and/or one or more of the storage arrays 106 (e.g., such as implementing an instance of the IO tool coordination system 112 utilizing the storage controllers 110 of the storage array 106-1). In some embodiments, the IO tool coordination system 112 is implemented on a cloud computing platform or other type of information technology (IT) infrastructure, where one or more of the host devices 102 and/or one or more of the storage arrays 106 may also be implemented or run as part of the cloud computing platform or other IT infrastructure.

In some embodiments, the storage arrays 106 in the FIG. 1 embodiment provide or implement multiple distinct storage tiers of a multi-tier storage system. By way of example, a given multi-tier storage system may comprise a fast tier or performance tier implemented using flash storage devices or other types of SSDs, and a capacity tier implemented using HDDs, possibly with one or more such tiers being server based. A wide variety of other types of storage devices and multi-tier storage systems can be used in other embodiments, as will be apparent to those skilled in the art. The particular storage devices used in a given storage tier may be varied depending on the particular needs of a given embodiment, and multiple distinct storage device types may be used within a single storage tier. As indicated previously, the term “storage device” as used herein is intended to be broadly construed, and so may encompass, for example, SSDs, HDDs, flash drives, hybrid drives or other types of storage products and devices, or portions thereof, and illustratively include logical storage devices such as LUNs.

It should be appreciated that a multi-tier storage system may include more than two storage tiers, such as one or more “performance” tiers and one or more “capacity” tiers, where the performance tiers illustratively provide increased IO performance characteristics relative to the capacity tiers and the capacity tiers are illustratively implemented using relatively lower cost storage than the performance tiers. There may also be multiple performance tiers, each providing a different level of service or performance as desired, or multiple capacity tiers.

The host devices 102, the storage arrays 106 and the IO tool coordination system 112 in the FIG. 1 embodiment are assumed to be implemented using at least one processing platform, with each processing platform comprising one or more processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The host devices 102, the storage arrays 106 and the IO tool coordination system 112 may be implemented on respective distinct processing platforms, although numerous other arrangements are possible. For example, in some embodiments at least portions of one or more of the host devices 102, one or more of the storage arrays 106 and/or the IO tool coordination system 112 are implemented on the same processing platform. One or more of the storage arrays 106 can therefore be implemented at least in part within at least one processing platform that implements at least a subset of the host devices 102 and/or the IO tool coordination system 112.

The network 104 may be implemented using multiple networks of different types to interconnect storage system components. For example, the network 104 may comprise a SAN that is a portion of a global computer network such as the Internet, although other types of networks can be part of the SAN, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Although in some embodiments certain commands used by the host devices 102 to communicate with the storage arrays 106 illustratively comprise SCSI commands, other types of commands and command formats can be used in other embodiments. For example, some embodiments can implement IO operations utilizing command features and functionality associated with NVM Express (NVMe), as described in the NVMe Specification, Revision 1.3, May 2017, which is incorporated by reference herein. Other storage protocols of this type that may be utilized in illustrative embodiments disclosed herein include NVMe over Fabric, also referred to as NVMeoF, and NVMe over Transmission Control Protocol (TCP), also referred to as NVMe/TCP.

The storage array 106-1 in the present embodiment is assumed to comprise a persistent memory that is implemented using a flash memory or other type of non-volatile memory of the storage array 106-1. More particular examples include NAND-based flash memory or other types of non-volatile memory such as resistive RAM, phase change memory, spin torque transfer magneto-resistive RAM (STT-MRAM) and Intel Optane™ devices based on 3D XPoint™ memory. The persistent memory is further assumed to be separate from the storage devices 108 of the storage array 106-1, although in other embodiments the persistent memory may be implemented as a designated portion or portions of one or more of the storage devices 108. For example, in some embodiments the storage devices 108 may comprise flash-based storage devices, as in embodiments involving all-flash storage arrays, or may be implemented in whole or in part using other types of non-volatile memory.

As mentioned above, communications between the host devices 102 and the storage arrays 106 may utilize PCIe connections or other types of connections implemented over one or more networks. For example, illustrative embodiments can use interfaces such as Internet SCSI (iSCSI), Serial Attached SCSI (SAS) and Serial ATA (SATA). Numerous other interfaces and associated communication protocols can be used in other embodiments.

The storage arrays 106 in some embodiments may be implemented as part of a cloud-based system. The IO tool coordination system 112 may also or alternatively be implemented as part of the cloud-based system.

It should therefore be apparent that the term “storage array” as used herein is intended to be broadly construed, and may encompass multiple distinct instances of a commercially-available storage array.

Other types of storage products that can be used in implementing a given storage system in illustrative embodiments include software-defined storage, cloud storage, object-based storage and scale-out storage. Combinations of multiple ones of these and other storage types can also be used in implementing a given storage system in an illustrative embodiment.

In some embodiments, a storage system comprises first and second storage arrays arranged in an active-active configuration. For example, such an arrangement can be used to ensure that data stored in one of the storage arrays is replicated to the other one of the storage arrays utilizing a synchronous replication process. Such data replication across the multiple storage arrays can be used to facilitate failure recovery in the system 100. One of the storage arrays may therefore operate as a production storage array relative to the other storage array which operates as a backup or recovery storage array.

It is to be appreciated, however, that embodiments disclosed herein are not limited to active-active configurations or any other particular storage system arrangements. Accordingly, illustrative embodiments herein can be configured using a wide variety of other arrangements, including, by way of example, active-passive arrangements, active-active Asymmetric Logical Unit Access (ALUA) arrangements, and other types of ALUA arrangements.

These and other storage systems can be part of what is more generally referred to herein as a processing platform comprising one or more processing devices each comprising a processor coupled to a memory. A given such processing device may correspond to one or more virtual machines or other types of virtualization infrastructure such as Docker containers or other types of LXCs. As indicated above, communications between such elements of system 100 may take place over one or more networks.

The term “processing platform” as used herein is intended to be broadly construed so as to encompass, by way of illustration and without limitation, multiple sets of processing devices and one or more associated storage systems that are configured to communicate over one or more networks. For example, distributed implementations of the host devices 102 are possible, in which certain ones of the host devices 102 reside in one data center in a first geographic location while other ones of the host devices 102 reside in one or more other data centers in one or more other geographic locations that are potentially remote from the first geographic location. The storage arrays 106 and the IO tool coordination system 112 may be implemented at least in part in the first geographic location, the second geographic location, and one or more other geographic locations. Thus, it is possible in some implementations of the system 100 for different ones of the host devices 102, the storage arrays 106 and the IO tool coordination system 112 to reside in different data centers.

Numerous other distributed implementations of the host devices 102, the storage arrays 106 and the IO tool coordination system 112 are possible. Accordingly, the host devices 102, the storage arrays 106 and the IO tool coordination system 112 can also be implemented in a distributed manner across multiple data centers.

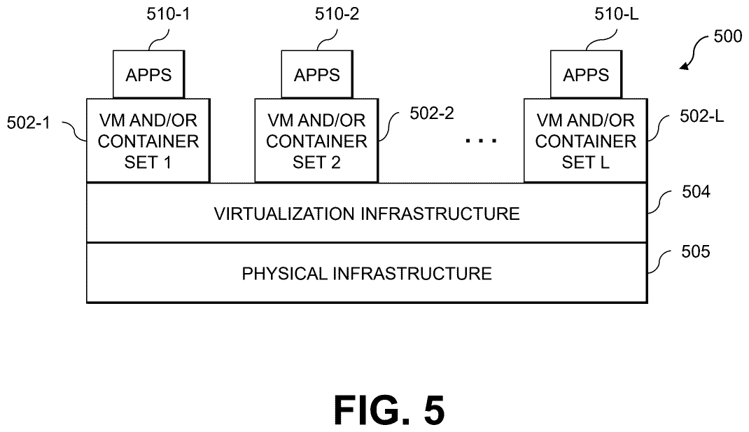

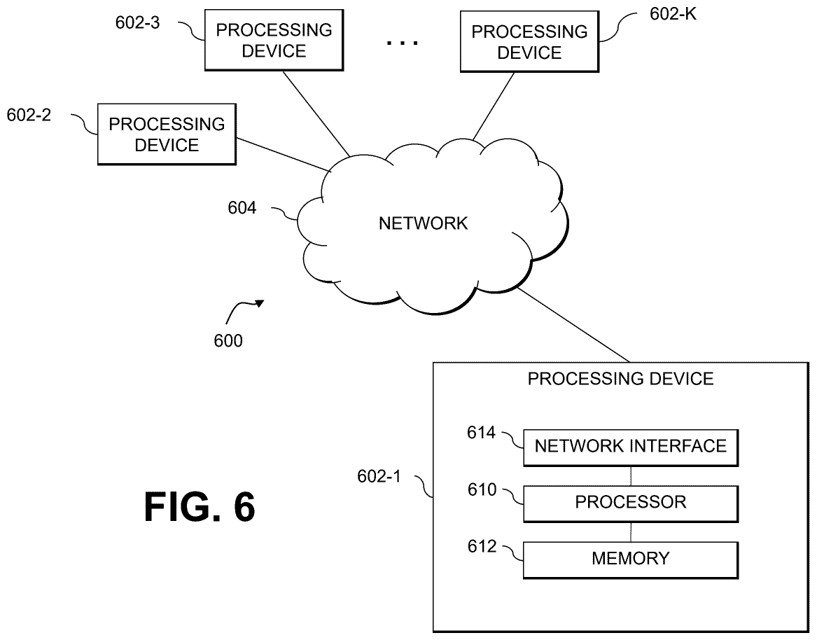

Additional examples of processing platforms utilized to implement portions of the system 100 in illustrative embodiments will be described in more detail below in conjunction with FIGS. 5 and 6.

It is to be understood that the particular set of elements shown in FIG. 1 for selection and configuration of IO software tools for execution of IO workloads is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

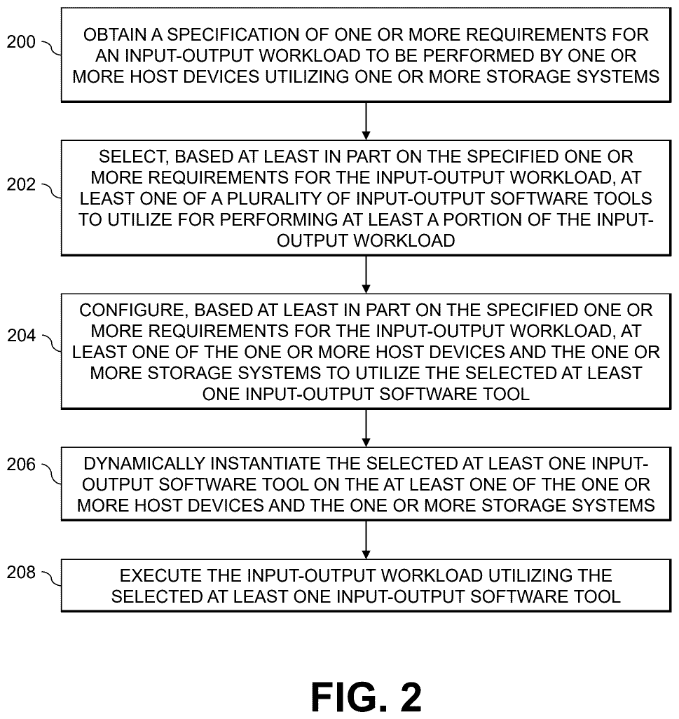

An exemplary process for selection and configuration of IO software tools for execution of IO workloads will now be described in more detail with reference to the flow diagram of FIG. 2. It is to be understood that this particular process is only an example, and that additional or alternative processes for selection and configuration of IO software tools for execution of IO workloads may be used in other embodiments.

In this embodiment, the process includes steps 200 through 208. These steps are assumed to be performed by the IO tool coordination system 112 utilizing the UI 114, the IO tools 116, the IO tool selection logic 118 and the IO workload execution logic 120. The process begins with step 200, obtaining (e.g., via the UI 114) a specification of one or more requirements for an IO workload to be performed by one or more of the host devices 102 utilizing one or more of the storage arrays 106.

In step 202, at least one of the IO tools 116 (e.g., software IO tools) is selected to utilize for performing at least a portion of the IO workload based at least in part on the specified one or more requirements for the IO workload. The IO tools 116 may comprise two or more types of IO tools, such as a first type of IO tools developed by a vendor of the storage arrays 106 and a second type of IO tools not developed by the vendor of the storage arrays 106, a first type of IO tools configured for execution of a first set of one or more IO protocols and at least a second type of IO software tools configured for execution of a second set of one or more IO protocols different than the first set of one or more IO protocols, etc. The IO tools 116 are registered with the IO tool coordination system 112, where as part of registration of a given one of the IO tools 116 one or more parameters associated with the given IO tool are specified. The one or more parameters associated with the given IO tool may comprise one or more of: a description of the given IO tool; a syntax for usage of the given IO tool; one or more options required for execution of IO workloads utilizing the given IO tool; a description of one or more designated types of IO protocols supported by the given IO tool; etc.

In step 204, at least one of the one or more host devices 102 and the one or more storage arrays 106 is configured to utilize the selected at least one IO tool, based at least in part on the specified one or more requirements for the IO workload. Step 204 may include instantiating one or more storage protocol-specific storage clients on the one or more host devices 102 and creating one or more storage protocol-specific exports on the one or more storage arrays 106. Instantiating the one or more storage protocol-specific storage clients on a given one of the one or more host devices 102 may comprise installing one or more prerequisite software packages for the one or more storage protocol-specific storage clients on the given host device.

In step 206, the selected at least one IO tool is dynamically instantiated on the at least one of the one or more host devices 102 and the one or more storage arrays 106. Step 206 may include running the selected at least one IO tool on-demand, in real-time or near real-time, without requiring any manual user input.

In step 208, the IO workload is executed utilizing the selected at least one IO tool. The FIG. 2 process may further include generating, based at least in part on the execution of the IO workload utilizing the selected at least one IO tool, one or more logs. Responsive to detecting one or more issues encountered in association with execution of the IO workload, the FIG. 2 process may include performing debugging utilizing the generated one or more logs. The FIG. 2 process may further or alternatively include providing, via the UI 114, access to the generated one or more logs.

In some embodiments, the IO workload comprises performance benchmarking testing of a storage system (e.g., one or more of the storage arrays 106) and the request specifies one or more test environment details for the performance benchmark testing and one or more performance metrics to analyze. Step 202 may be based at least in part on the specified one or more performance metrics to analyze, and step 204 may include determining a test bed configuration based on the specified one or more test environment details, and generating a test bed on at least one of at least one of the one or more host devices 102 and at least one of the one or more storage arrays 106 in accordance with the determined test bed configuration. The FIG. 2 process may further include providing, via the UI 114, performance results for the performance benchmark testing.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes for different IO workloads, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Generally, there are a variety of IO tools available for an enterprise, organization or other entity that executes IO workloads. The availability of different IO tools presents technical challenges in selecting the appropriate IO tool for a given IO workload based on user requirements for the given IO workload. It is desired to make the use of IO tools an easy process for end-users. Conventional approaches suffer from various technical challenges, in that end-users must learn about the different IO tools which are available in order to start using such IO tools. This may involve tool exploration, where end-users must read through documentation and references, and sometimes read and understand code and overall flow and what features or benefits the different IO tools will provide. Thus, it is a difficult and time-consuming process for end-users to choose the best-suited IO tool based on the requirements for a given IO workload. Further, there are various technical challenges associated with debugging IO routines performed using different IO tools, and in reproducing user escalation scenarios. Illustrative embodiments provide technical solutions for a one-stop tool (e.g., the IO tool coordination system 112) that enables better utilization of different available IO tools in order to take advantage of different features/offerings of the different available IO tools.

The IO tool coordination system 112 provides various technical advantages, including providing for a wide variety of IO tools to be made available at one destination, for making such IO tools easy to use, and for debugging any failures encountered during use of such IO tools. The IO tool coordination system 112 provides a flexible approach for performing end-to-end IO operations with improved logging and reporting. The IO tool coordination system 112 also provides configurable and customizable IO profiling functionality as per user requirements. Advantageously, the IO tool coordination system 112 allows for integration or onboarding of new IO tools as needed. The IO tool coordination system 112 also does not require or depend on end-users thereof learning or understanding the different available IO tools, and prerequisites are automatically taken care of. Further, the IO tool coordination system 112 provides a common software support solution where multiple product teams can benefit from the use of available IO tools which are hosted at one place.

The IO tool coordination system 112 provides the UI 114 (e.g., a graphical UI (GUI)) that is made available to users (e.g., of the host devices 102), allowing in some embodiments for “one-click” or “one-stop” access to the plurality of IO tools 116. Advantageously, users need to provide only minimal input via the UI 114, enabling the IO tool coordination system 112 to select among the available IO tools 116 for user in executing different IO workloads.

The IO tool coordination system 112 may be utilized for various use case scenarios. Consider, for example, a user that needs to perform a multi-protocol IO load, where the user does not have knowledge of which IO tools are suitable for performing the multi-protocol IO load. The user may input, via the UI 114 of the IO tool coordination system 112, storage cluster and client details for the storage system (e.g., one or more of the storage arrays 106) on which the multi-protocol IO load is to be executed, and requests the IO tool coordination system 112 to perform the required IO operations for the multi-protocol IO load. The IO tool coordination system 112 will read the storage cluster and client details, and assess the user requirements for the IO workload to be performed which, in this example, use case, includes multi-protocol IO load. The IO tool coordination system 112 will utilize the IO tool selection logic 118 to select, from among the available IO tools 116, the best or most optimal one or ones of the IO tools 116 for performing the required IO operations for the multi-protocol IO load.

When there are multiple IO tools 116 available, it is advantageous to choose the “correct” IO tool for each IO workload. The IO tool coordination system 112 may maintain or keep records of significance (e.g., in an IO tool database), and utilize the IO tool selection logic 118 to suitably map the user requirements for each IO workload to the different available IO tools 116. The IO tool coordination system 112 will return an appropriate IO tool name (e.g., Powerload in the example above for the multi-protocol IO load) for one or more of the IO tools 116 which satisfy the user requirements for particular IO workloads. The IO tool coordination system 112 will, if necessary, install any software prerequisites which are required for running the selected IO tool (e.g., on the host devices 102 and/or the storage arrays 106). For example, in the case of the Powerload IO tool, packages are installed on the clients (e.g., a given one of the host devices 102 which initiated the request to perform the multi-protocol IO load) and Network File System (NFS) and/or Server Message Block (SMB) exports are created on the cluster side (e.g., one or more of the storage arrays 106). The IO tool coordination system 112 will utilize the IO workload execution logic 120 to generate a configuration, as per the user requirements, to dynamically instantiate the selected IO tool, and to utilize the selected IO tool (e.g., Powerload) to start the multi-protocol IO load from the NFS and SMB clients. The IO tool coordination system 112 may further utilize the IO workload execution logic 120 to collect logs (e.g., end-to-end logs), and provide a log link (e.g., via the UI 114) to the user which requested execution of the IO workload. The IO tool coordination system 112 can advantageously provide improved logging and reporting functionality, which will help in debugging any failures or issues which are found or encountered in conjunction with execution of IO workloads.

As another use case scenario, consider a user that seeks to perform performance benchmark testing. In this example, the IO tool coordination system 112 will utilize the IO tool selection logic 118 to automatically determine the best performance testing IO tool to test performance as per the specific benchmark testing requirements specified by the user via the UI 114. The IO tool coordination system 112 may provide, via the UI 114, an IO profile that can be used for performance testing. The user has the choice, via the UI 114, to configure their own IO profile for measuring performance, or to utilize the recommended or default IO profile that is determined by the IO tool coordination system 112. The user will specify, via the UI 114, test environment details (e.g., a test bed for performing the performance testing, such as client and cluster configurations for one or more of the host devices 102 and the storage arrays 106). The IO tool coordination system 112 will utilize the IO workload execution logic 120 to assess the requirements and perform the required testing, and will provide performance testing results to the user via the UI 114.

As a further use case scenario, consider a user which has a given IO tool (e.g., an unstructured data generation IO tool) that they wish to integrate into the IO tool coordination system 112 (e.g., to register or onboard the given IO tool as one of the available IO tools 116), so that other users or teams can take advantage of the given IO tool. The IO tool coordination system 112 may provide, via the UI 114, UI features for a new IO tool integration wrapper. The UI features for the new IO tool integration wrapper provide an automated wrapper which will ask for inputs while integrating the given IO tool in the IO tool coordination system 112. Such inputs may be for various types of information associated with the given IO tool, such as: a high-level description of the given IO tool; syntax or usage of the given IO tool; necessary options/parameters for getting started with the given IO tool; and any other information required for utilizing the given IO tool. The automated wrapper has the intelligence to understand the tool details based on the received information, and will integrate the given IO tool into the IO tool coordination system 112 as one of the available IO tools 116.

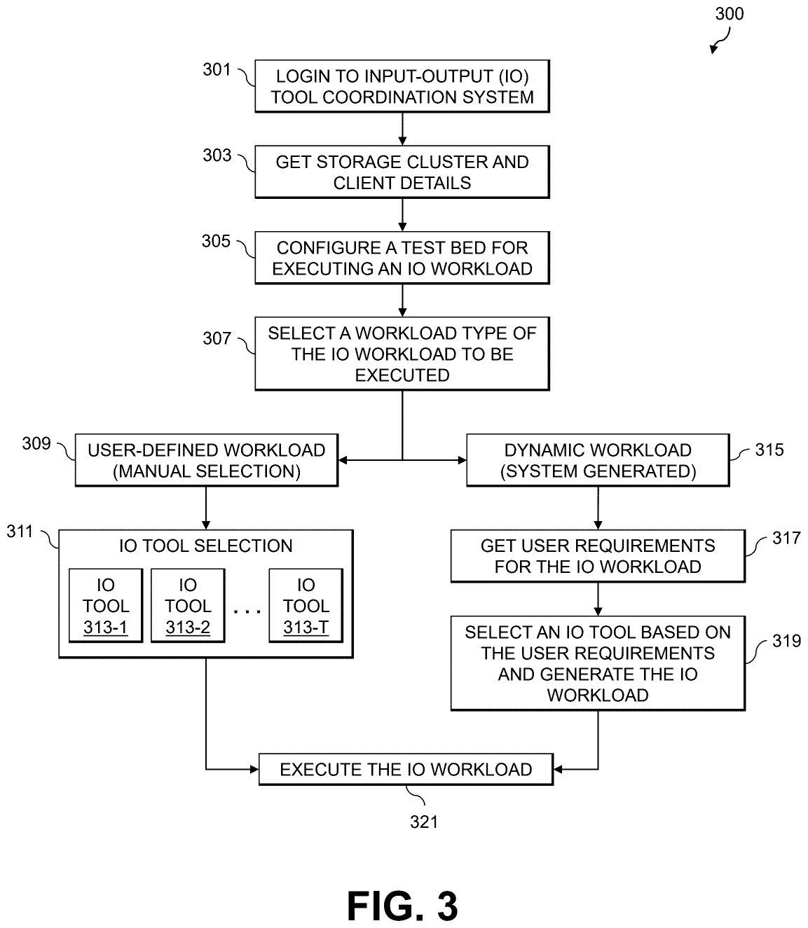

FIG. 3 shows a process flow 300 for utilization of the IO tool coordination system 112. The process flow 300 begins with block 301, where a user logs in to the IO tool coordination system 112 via the UI 114. In block 303, the UI 114 gets storage cluster and client details for a given IO workload that is to be performed. In block 305, the IO tool coordination system 112 configures a test bed for execution of the given IO workload (e.g., using the storage cluster and client details input via the UI 114). In block 307, the user selects, via the UI 114, a workload type of the given IO workload that is to be executed. The process flow 300 then proceeds to either user-defined or manual selection of workload type processing block 309 or dynamic or system generated workload type processing block 315. For the user-defined or manual selection of workload type processing block 309, the process flow 300 proceeds to IO tool selection in block 311 (e.g., which may utilize the IO tool selection logic 118), where a user manually selects from among a set of IO tool types 313-1, 313-2, . . . 313-T (collectively, IO tool types 313). In some embodiments, the IO tool type 313-1 includes PowerScale Tools (e.g., Agefs.pl, FSTools, etc.), the IO tool type 313-2 includes open source tools (e.g., IOStat, etc.), and the IO tool type 313-T includes performance tools (e.g., IOZone, FIO, etc.). For dynamic or system generated workload type processing block 315, the process flow 300 proceeds to get user requirements for the IO workload in block 317. The IO tool coordination system 112 then utilizes the IO tool selection logic 118 in block 319 to select an IO tool based on the user requirements and generates the IO workload for execution. Following block 311 or block 319, the process flow 300 proceeds to block 321 where the IO workload execution logic 120 is utilized to execute the IO workload utilizing the selected IO tool.

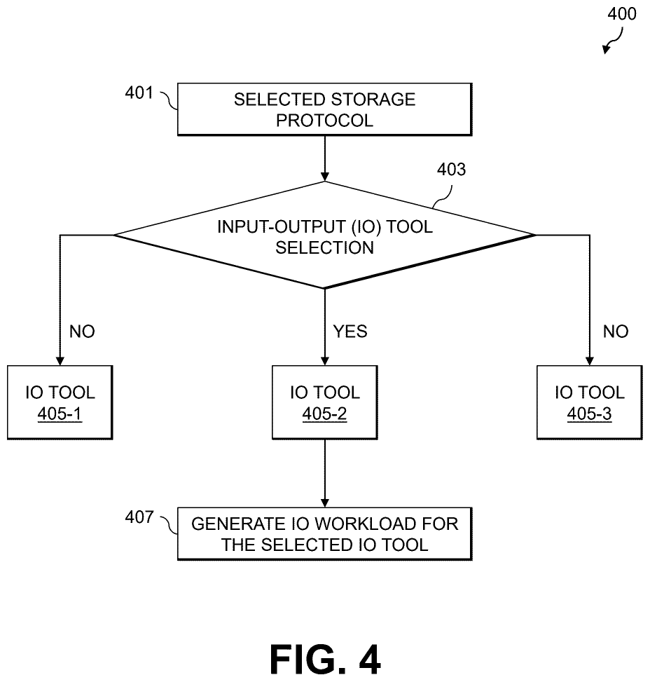

FIG. 4 shows a process flow 400 which may be executed as part of block 319. In the process flow 400, the user inputs a selected storage protocol (e.g., Amazon Simple Storage Service (S3) protocol load) in block 401. In block 403, IO tool selection is performed from among a set of IO tools 405-1, 405-2 and 405-3 (collectively, IO tools 405). Continuing with the example of the S3 protocol load, the IO tool 405-1 may be the Agefs.pl tool, the IO tool 405-2 may be the FSKhan tool, and the IO tool 405-3 may be the Powerload tool. In this example, the IO tool 405-2 is selected as per the user requirements for the IO workload to be executed. This may include, for example, analyzing the performance stats, execution time and other performant parameters associated with the different IO tools 405 in order to identify the correct or optimal one of the IO tools 405 given the user requirements. The process flow 400 then proceeds to block 407 where the IO workload is generated for the selected IO tool 405-2.

The technical solutions described herein provide various technical advantages. For example, the IO tool coordination system 112 can recommend performing required actions (e.g., IO workloads) on optimal ones of a set of available IO tools (e.g., IO tools 116) based on user requirements. The IO tool coordination system 112 enables multiple IO tools to run in parallel on the same protocol shares, without barriers of IO tool knowledge. The IO tool coordination system 112 can be consumed or utilized by any number of users (e.g., different organizations, teams, users, etc. which are associated with an enterprise, organization or other entity which either operates the IO tool coordination system 112 or which subscribes to the IO tool coordination system 112). The IO tool coordination system 112, via the UI 114, allows for integration of additional IO tools which can then be made available for selection as desired for different IO workloads. Further, the IO tool coordination system 112's intelligent selection of IO tools for different IO workloads leads to better utilization of IO tools as per user requirements, and hassle-free choice of IO tools without any dependency (e.g., requiring users to learn or understand different IO tools).

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for selection and configuration of IO software tools for execution of IO workloads will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that may be utilized to implement at least a portion of the information processing system 100 in FIG. 1. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 may comprise respective VMs, respective sets of one or more containers, or respective sets of one or more containers running in VMs.

In some implementations of the FIG. 5 embodiment, the VMs/container sets 502 comprise respective VMs implemented using virtualization infrastructure 504 that comprises at least one hypervisor. A hypervisor platform may be used to implement a hypervisor within the virtualization infrastructure 504, where the hypervisor platform has an associated virtual infrastructure management system. The underlying physical machines may comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 602-1 in the processing platform 600 comprises a processor 610 coupled to a memory 612.

The processor 610 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 612 may comprise random access memory (RAM), read-only memory (ROM), flash memory or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for selection and configuration of IO software tools for execution of IO workloads as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, storage systems, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to obtain a specification of one or more requirements for an input-output workload to be performed by one or more host devices utilizing one or more storage systems;
to select, based at least in part on the specified one or more requirements for the input-output workload, at least one of a plurality of input-output software tools to utilize for performing at least a portion of the input-output workload;
to configure, based at least in part on the specified one or more requirements for the input-output workload, at least one of the one or more host devices and the one or more storage systems to utilize the selected at least one input-output software tool;
to dynamically instantiate the selected at least one input-output software tool on said at least one of the one or more host devices and the one or more storage systems; and
to execute the input-output workload utilizing the selected at least one input-output software tool.

2. The apparatus of claim 1 wherein the plurality of input-output software tools comprise two or more types of input-output software tools.

3. The apparatus of claim 2 wherein the two or more types of input-output software tools comprise a first type of input-output software tools developed by a vendor of the one or more storage systems and at least a second type of input-output software tools not developed by the vendor of the one or more storage systems.

4. The apparatus of claim 2 wherein the two or more types of input-output software tools comprise a first type of input-output software tools configured for execution of a first set of one or more input-output protocols and at least a second type of input-output software tools configured for execution of a second set of one or more input-output protocols, the second set of one or more input-output protocols being different than the first set of one or more input-output protocols.

5. The apparatus of claim 1 wherein the plurality of input-output software tools are registered with the at least one processing device, wherein as part of registration of a given one of the plurality of input-output software tools, one or more parameters associated with the given input-output software tool are specified.

6. The apparatus of claim 5 wherein the one or more parameters associated with the given input-output software tool comprise: a description of the given input-output software tool and a syntax for usage of the given input-output software tool.

7. The apparatus of claim 5 wherein the one or more parameters associated with the given input-output software tool comprise specification of one or more options required for execution of input-output workloads utilizing the given input-output software tool.

8. The apparatus of claim 5 wherein the one or more parameters associated with the given input-output software tool comprise a description of one or more designated types of input-output protocols supported by the given input-output software tool.

9. The apparatus of claim 1 wherein configuring said at least one of the one or more host devices and the one or more storage systems comprises:
instantiating one or more storage protocol-specific storage clients on the one or more host devices; and
creating one or more storage protocol-specific exports on the one or more storage systems.

10. The apparatus of claim 9 wherein instantiating the one or more storage protocol-specific storage clients on a given one of the one or more host devices comprises installing one or more prerequisite software packages for the one or more storage protocol-specific storage clients on the given host device.

11. The apparatus of claim 1 wherein the at least one processing device is further configured to generate, based at least in part on the execution of the input-output workload utilizing the selected at least one input-output software tool, one or more logs.

12. The apparatus of claim 11 wherein the at least one processing device is further configured, responsive to detecting one or more issues encountered in association with execution of the input-output workload, to perform debugging utilizing the generated one or more logs.

13. The apparatus of claim 11 wherein the at least one processing device is further configured to provide, via a user interface, access to the generated one or more logs.

14. The apparatus of claim 1 wherein:
the input-output workload comprises performance benchmarking testing of the one or more storage systems and the specified one or more requirements comprise one or more test environment details for the performance benchmark testing and one or more performance metrics to analyze;
selecting the at least one of the plurality of input-output software tools is based at least in part on the specified one or more performance metrics to analyze;
configuring said at least one of the one or more host devices and the one or more storage systems comprises: determining a test bed configuration based on the specified one or more test environment details; and generating a test bed on at least one of at least one of the one or more host devices and at least one of the one or more storage systems in accordance with the determined test bed configuration; and
the at least one processing device is further configured to provide, via a user interface, performance results for the performance benchmark testing.

15. A computer program product comprising a non-transitory processor-readable storage medium having stored therein program code of one or more software programs, wherein the program code when executed by at least one processing device causes the at least one processing device:
to obtain a specification of one or more requirements for an input-output workload to be performed by one or more host devices utilizing one or more storage systems;
to select, based at least in part on the specified one or more requirements for the input-output workload, at least one of a plurality of input-output software tools to utilize for performing at least a portion of the input-output workload;
to configure, based at least in part on the specified one or more requirements for the input-output workload, at least one of the one or more host devices and the one or more storage systems to utilize the selected at least one input-output software tool;
to dynamically instantiate the selected at least one input-output software tool on said at least one of the one or more host devices and the one or more storage systems; and
to execute the input-output workload utilizing the selected at least one input-output software tool.

16. The computer program product of claim 15 wherein configuring said at least one of the one or more host devices and the one or more storage systems comprises:
instantiating one or more storage protocol-specific storage clients on the one or more host devices; and
creating one or more storage protocol-specific exports on the one or more storage systems.

17. The computer program product of claim 16 wherein instantiating the one or more storage protocol-specific storage clients on a given one of the one or more host devices comprises installing one or more prerequisite software packages for the one or more storage protocol-specific storage clients on the given host device.

18. A method comprising:
obtaining a specification of one or more requirements for an input-output workload to be performed by one or more host devices utilizing one or more storage systems;
selecting, based at least in part on the specified one or more requirements for the input-output workload, at least one of a plurality of input-output software tools to utilize for performing at least a portion of the input-output workload;
configuring, based at least in part on the specified one or more requirements for the input-output workload, at least one of the one or more host devices and the one or more storage systems to utilize the selected at least one input-output software tool;
dynamically instantiating the selected at least one input-output software tool on said at least one of the one or more host devices and the one or more storage systems; and
executing the input-output workload utilizing the selected at least one input-output software tool;
wherein the method is performed by at least one processing device comprising a processor coupled to a memory.

19. The method of claim 18 wherein configuring said at least one of the one or more host devices and the one or more storage systems comprises:
instantiating one or more storage protocol-specific storage clients on the one or more host devices; and
creating one or more storage protocol-specific exports on the one or more storage systems.

20. The method of claim 19 wherein instantiating the one or more storage protocol-specific storage clients on a given one of the one or more host devices comprises installing one or more prerequisite software packages for the one or more storage protocol-specific storage clients on the given host device.
